(19) United States
(12) Patent Application Publication
(10) Pub. No.: US 2023/0101530 A1
(43) Pub. Date: Mar. 30, 2023

(54) SYSTEM AND METHOD OF PROCESSING A DATA ACCESS REQUEST

(71) Applicant: The Toronto-Dominion Bank, Toronto (CA)

(72) Inventors: Shishir Dattatraya BHAT, Toronto (CA); Marcus Edward FURLONG, Atlanta, GA (US); Katherine KANCZUGA, Toronto (CA); Sumathi SEETHARAMAN, Etobicoke (CA)

(21) Appl. No.: 17/490,208

(22) Filed: Sep. 30, 2021

(51) Int. Cl. G06F 21/33; G06F 21/44; G06F 21/64; G06F 21/62; G06F 9/54; G06F 16/955

(52) U.S. Cl. CPC G06F 21/33; G06F 21/44; G06F 21/645; G06F 21/62; G06F 9/547; G06F 16/955; G06F 2221/2141

(57) ABSTRACT

Computing platforms, methods, and storage media for processing a data request are disclosed. Exemplary implementations may: receive a data transfer request including data transfer instructions associated with the data transfer; obtain an aggregator access profile specifying application programming interface (API) access to be granted to a data aggregator with respect to one or more APIs; obtain a user account authorization token specifying access to be granted to the data aggregator with respect to one or more user accounts; determine access permissions associated with the data transfer instructions based on a combination of the aggregator access profile and the user account authorization token; and transmit an access notification based on the determined access permissions, the access notification specifying the combination of the one or more APIs and the one or more user accounts to which the data aggregator is granted access. Application-specific account permissions and data type permissions may be specified.

### FIELD

The present disclosure relates to sharing user data, including but not limited to computing platforms, methods, and storage media for processing a data access request.

### BACKGROUND

Sharing user data is useful in a number of different scenarios. Open banking is a mechanism that enables the sharing of user or customer financial data securely, and at the customer's request, between financial service providers. Often, open banking includes sharing financial data between a financial institution and a third party application.

For open banking and sharing banking credentials with fintech applications, a data aggregator, or simply aggregator, is frequently used, for example using a tool or platform such as Plaid. A financial institution (FI) communicates with the data aggregator to manage access to customer financial institution data for a number of different fintech apps.

In known approaches, the data aggregator manages the data access, and tokens are typically issued per financial institution-aggregator pair.

Improvements in approaches of processing a data access request are desirable.

### SUMMARY

One aspect of the present disclosure relates to a computing platform configured for processing a data request. The computing platform may include one or more hardware processors configured by machine-readable instructions stored on a non-transient computer-readable storage medium. The processor(s) may be configured to receive, at the computing platform and from a user device associated with a user, a data transfer request including data transfer instructions associated with the data transfer. The processor(s) may be configured to obtain, by the computing platform, an aggregator access profile specifying application programming interface (API) access to be granted to a data aggregator with respect to one or more APIs. The processor(s) may be configured to obtain, by the computing platform, a user account authorization token specifying access to be granted to the data aggregator with respect to one or more user accounts. The processor(s) may be configured to determine, by the computing platform, access permissions associated with the data transfer instructions based on a combination of the aggregator access profile and the user account authorization token. The processor(s) may be configured to transmit, by the computing platform and to the data aggregator, an access notification based on the determined access permissions, the access notification specifying the combination of the one or more APIs and the one or more user accounts to which the data aggregator is granted access.

Another aspect of the present disclosure relates to a method for processing a data request. The method may include receiving, at an apparatus and from a user device associated with a user, a data transfer request including data transfer instructions associated with the data transfer. The method may include obtaining, by the apparatus, an aggregator access profile specifying application programming interface access to be granted to a data aggregator with respect to one or more APIs. The method may include obtaining, by the apparatus, a user account authorization token specifying access to be granted to the data aggregator with respect to one or more user accounts. The method may include determining, by the apparatus, access permissions associated with the data transfer instructions based on a combination of the aggregator access profile and the user account authorization token. The method may include transmitting, by the apparatus and to the data aggregator, an access notification based on the determined access permissions. The access notification may specify the combination of the one or more APIs and the one or more user accounts to which the data aggregator is granted access.

Still another aspect of the present disclosure relates to a non-transient computer-readable storage medium having instructions embodied thereon, the instructions being executable by one or more processors to perform a computer-implemented method for processing a data request. The method may include obtaining, by the apparatus, an aggregator access profile specifying application programming interface access to be granted to a data aggregator with respect to one or more APIs. The method may include obtaining, by the apparatus, a user account authorization token specifying access to be granted to the data aggregator with respect to one or more user accounts. The method may include determining, by the apparatus, access permissions associated with the data transfer instructions based on a combination of the aggregator access profile and the user account authorization token. The method may include transmitting, by the apparatus and to the data aggregator, an access notification based on the determined access permissions. The access notification may specify the combination of the one or more APIs and the one or more user accounts to which the data aggregator is granted access.

### BRIEF DESCRIPTION OF THE DRAWINGS

Embodiments of the present disclosure will now be described, by way of example only, with reference to the attached Figures.

FIG. 1 illustrates a system configured for processing a data access request, in accordance with one or more embodiments.

FIG. 2 illustrates another system configured for processing a data access request, in accordance with one or more embodiments.

FIG. 3 illustrates a method for processing a data access request, in accordance with one or more embodiments.

FIG. 4 illustrates an example indication of a means for modifying access permissions for a method for processing a data access request, in accordance with one or more embodiments.

FIG. 5 illustrates a method for processing a data request, in accordance with one or more embodiments.

### DETAILED DESCRIPTION

Computing platforms, methods, and storage media for processing a data request are disclosed. Exemplary implementations may: receive a data transfer request including data transfer instructions associated with the data transfer; obtain an aggregator access profile specifying application programming interface access to be granted to a data aggregator with respect to one or more APIs; obtain a user account authorization token specifying access to be granted to the data aggregator with respect to one or more user accounts; determine access permissions associated with the data transfer instructions based on a combination of the aggregator access profile and the user account authorization token; and transmit an access notification based on the determined access permissions, the access notification specifying the combination of the one or more APIs and the one or more user accounts to which the data aggregator is granted access. Application-specific account permissions and data type permissions may also be specified.

The present disclosure provides a system and method configured to specify granular access to user data, such as open banking data, using a combination of: a token specifying user account access; and an aggregator access profile specifying API access.

In an embodiment, a user may choose to share data out, for example to a third party application, on a granular level. Granular sharing of user data is enabled using a combination of a token and an aggregator access profile. The token may specify the user account(s) to which access is granted. The aggregator access profile may specify particular types of account data to which access is granted, for example by selectively granting access to one or more associated APIs that may be operable with respect to selected account data types. For example, a combination of a user token and an aggregator access profile may grant a third party fintech app access to only a personal checking account, and only to account statements, but not grant access to account transactions. The system and method may use HTTP to modify permissions, for example using a combination of verb and uniform resource identifier (URI), without having to modify a configuration file.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

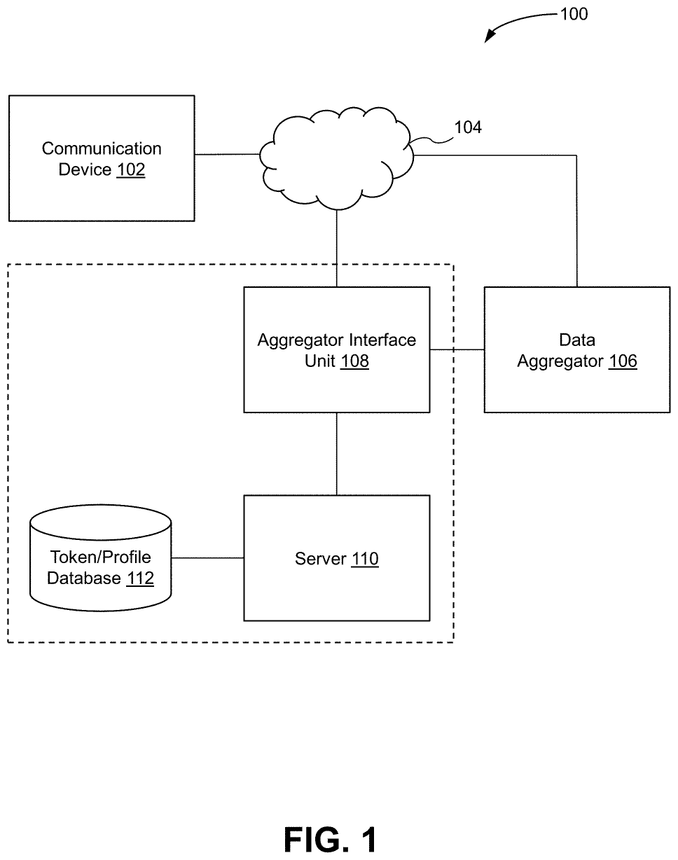

FIG. 1 illustrates a system 100 configured for processing a data access request, in accordance with one or more embodiments. The system 100 includes a communication device 102 in communication with a network 104, where the communication device is associated with a user of the system or a customer of the system. A data aggregator 106 is in communication with the network 104. The data aggregator 106 may aggregate data, such as financial data, and manage access to the aggregated data for a plurality of third party applications. For open banking and sharing banking credentials with fintech applications, an example of a data aggregator is a tool or platform such as Plaid.

An aggregator interface unit 108 is in communication with the network 104 and with the data aggregator 106. A server 110 is in communication with the aggregator interface unit 108 and with a token/profile database 112. The token/profile database 112 may be configured to store a plurality of aggregator access profiles. Each of the aggregator access profiles may specify application programming interface access to be granted to a data aggregator with respect to one or more APIs. The token/profile database 112 may be configured to store a plurality of a user account authorization tokens. Each of the user account authorization tokens may specify access to be granted to the data aggregator with respect to one or more user accounts associated with a user. The one or more APIs may be associated with an institution associated with the one or more user accounts.

In an embodiment, the aggregator interface unit 108, the server 110 and the token database 112 are associated with an institution, such as a financial institution. In an embodiment, the aggregator interface unit 108, the server 110 and the token database 112 are managed by, or under the control of, an institution, such as a financial institution. A financial institution may communicate with the data aggregator 106 to manage access to customer financial institution data for a number of different third party applications, for example fintech apps.

In another embodiment, the system operates with respect to an expanded user account authorization token. The expanded user account authorization token may specify one or more user accounts to which the data aggregator is granted access, and may also specify one or more data types to which the data aggregator is granted access. For example, an expanded user account authorization token may specify that a user grants access only to personal accounts, and only to account transactions, but not to account balances.

In such an embodiment, the aggregator interface unit 108 may be configured to: obtain an expanded user account authorization token specifying access to be granted to the data aggregator with respect to one or more user accounts and with respect to one or more data types; determine access permissions associated with the data transfer instructions based on the combination of the aggregator access profile and the expanded user account authorization token; and transmit, to the data aggregator, the access notification specifying the combination of the one or more APIs and the one or more user accounts and the one or more data types to which the data aggregator is granted access. The aggregator interface unit 108 may cooperate with the server 110 to grant the specified access to the combination of the one or more APIs and the one or more user accounts and the one or more data types.

For example, in an implementation, the server 110 enables access to first customer data associated with a first profile or data type for the user, and blocks access to second customer data associated with a second profile or data type for the customer. In another example embodiment, the server enables access to the first customer data associated with a first account linked to the first profile or data type for the customer, and blocks access to the second customer data associated a second account linked to the second profile or data type for the customer.

Aggregators typically call a number of different functions, and offer data. Embodiments of the present disclosure may limit API access to a subset of methods. Embodiments of the present disclosure may further advantageously include a dynamic control that allows a financial institution to define a profile, also known as an aggregator access profile, which defines the methods or APIs that a third party tool can access.

In an implementation, existing authentication methods are scaled up to work with external aggregators. In an embodiment, the data scope may be dynamically expanded for aggregators with a simple configuration.

In a specific implementation, a source control system such as BitBucket is used. Within BitBucket, configuration files may be used by an engineering team to add a new client, define a new client profile, or change a new client profile. In an implementation, each aggregator is assigned a client profile (or aggregator access profile) that defines the methods the data aggregator is allowed to access, for example by defining access to associated APIs. Alternatively, a Spring cloud config server may be hooked up to a source code repository. Spring config hosts configurations specifying which aggregator can access the APIs, and to define which APIs they can access. In an implementation, each time an application makes a request for access, the application may use this tool.

In a further embodiment, the system operates with respect to an application-specific user account authorization token. The application-specific user account authorization token may specify user accounts to which a specific third party application is granted access via the data aggregator. For example, an application-specific user account authorization token may specify that a user grants access to Application1 only to small business accounts via the data aggregator.

In such an embodiment, the aggregator interface unit 108 may be configured to: obtain an application-specific user account authorization token specifying access to be granted to a third party application with respect to an application-specific set of one or more user accounts; determine access permissions associated with the data transfer instructions based on the combination of the aggregator access profile and the application-specific user account authorization token; and transmit, to the data aggregator and for subsequent transmission to the third party application, the access notification specifying the combination of the one or more APIs and the application-specific set of one or more user accounts to which the data aggregator and the third party application are granted access. The aggregator interface unit 108 may cooperate with the server 110 to grant the specified access to the combination of the one or more APIs and the application-specific set of one or more user accounts.

In a yet further embodiment, the system operates with respect to an expanded application-specific user account authorization token. The expanded application-specific user account authorization token may specify user accounts to which a specific third party application is granted access via the data aggregator, and may also specify one or more data types to which the third party application is granted access via the data aggregator. For example, an expanded application-specific user account authorization token may specify that a user grants access to Application1 only to small business accounts via the data aggregator, and also restricts access only to account number and to account balances, but not to account transactions.

In such an embodiment, the aggregator interface unit 108 may be configured to: obtain an expanded application-specific user account authorization token specifying access to be granted to a third party application with respect to an application-specific set of one or more user accounts and with respect to an application-specific set of one or more data types; determine access permissions associated with the data transfer instructions based on the combination of the aggregator access profile and the expanded application-specific user account authorization token; and transmit, by the apparatus and to the data aggregator and for subsequent transmission to the third party application, the access notification specifying the combination of the one or more APIs and the application-specific set of one or more user accounts and the application-specific set of one or more data types to which the data aggregator and the third party application are granted access. The aggregator interface unit 108 may cooperate with the server 110 to grant the specified access to the combination of the one or more APIs and the application-specific set of one or more user accounts and the application-specific set of one or more data types.

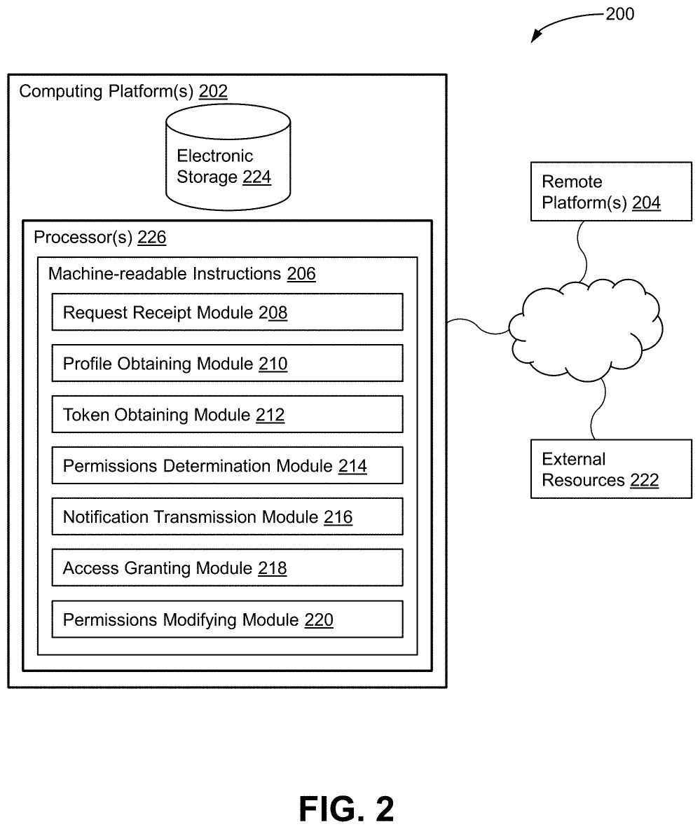

FIG. 2 illustrates a system 200 configured for processing a data request, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of request receipt module 208, profile obtaining module 210, token obtaining module 212, permissions determination module 214, notification transmission module 216, access granting module 218, permissions modifying module 220, and/or other instruction modules.

Request receipt module 208 may be configured to receive, at the computing platform and from a user device associated with a user, a data transfer request including data transfer instructions associated with the data transfer. The user device may include a customer device associated with a customer. The operation may be performed at an apparatus that is part of or associated with the computing platform.

Profile obtaining module 210 may be configured to obtain, by the computing platform, an aggregator access profile specifying application programming interface access to be granted to a data aggregator with respect to one or more APIs. The aggregator access profile may be based on permissions granted by, or specified by, an institution associated with the one or more APIs. The data type access profile may be obtained from a financial institution.

Token obtaining module 212 may be configured to obtain, by the computing platform, a user account authorization token specifying access to be granted to the data aggregator with respect to one or more user accounts. The user account authorization token may be based on account access permissions granted by, or specified by, the user. The one or more user accounts may include one or more customer accounts at a financial institution.

Permissions determination module 214 may be configured to determine, by the computing platform, access permissions associated with the data transfer instructions based on a combination of the aggregator access profile and the user account authorization token.

Notification transmission module 216 may be configured to transmit, by the computing platform and to the data aggregator, an access notification based on the determined access permissions. The access notification may specify the combination of the one or more APIs and the one or more user accounts to which the data aggregator is granted access.

Access granting module 218 may be configured to selectively grant the data aggregator access to the one or more APIs and the one or more user accounts to which the data aggregator is granted access. Each API may be uniquely associated with a selected account function, or with an account data type.

In an embodiment, the system is configured to perform token-based access permissions. Permissions determination module 214 may be configured to determine, by the computing platform, token-based access permissions associated with the data transfer instructions based on a combination of the user account authorization token and the user profile. Notification transmission module 216 may be configured to transmit, by the computing platform and to the third party application, a token-based access notification based on the determined access permissions. The token-based access notification may specify the combination of the one or more account data types and the one or more user accounts to which the third party application is granted access.

In another embodiment, the system operates with respect to an expanded user account authorization token, which may specify not only one or more user accounts to which the data aggregator is granted access, but also one or more data types to which the data aggregator is granted access. For example, an expanded user account authorization token may specify that a user grants access only to personal accounts, and only to account transactions, but not to account balances. Token obtaining module 212 may be configured to obtain, by the computing platform, an expanded user account authorization token specifying access to be granted to the data aggregator with respect to one or more user accounts and with respect to one or more data types. Permissions determination module 214 may be configured to determine, by the computing platform, access permissions associated with the data transfer instructions based on the combination of the aggregator access profile and the expanded user account authorization token. Notification transmission module 216 may be configured to transmit, by the computing platform and to the data aggregator, the access notification specifying the combination of the one or more APIs and the one or more user accounts and the one or more data types to which the data aggregator is granted access.

In a further embodiment, the system operates with respect to an application-specific user account authorization token, which may specify application-specific user accounts to which a third party application is granted access via the data aggregator. For example, an application-specific user account authorization token may specify that a user grants access to Application1 only to small business accounts via the data aggregator. Token obtaining module 212 may be configured to obtain, by the computing platform, an application-specific user account authorization token specifying access to be granted to a third party application with respect to an application-specific set of one or more user accounts. Permissions determination module 214 may be configured to determine, by the computing platform, access permissions associated with the data transfer instructions based on the combination of the aggregator access profile and the application-specific user account authorization token. Notification transmission module 216 may be configured to transmit, by the computing platform and to the data aggregator and for subsequent transmission to the third party application, the access notification specifying: the combination of the one or more APIs and the application-specific set of one or more user accounts to which the data aggregator and the third party application are granted access.

In a yet further embodiment, the system operates with respect to an expanded application-specific user account authorization token, which may specify application-specific user accounts to which a third party application is granted access via the data aggregator, and also one or more data types to which the third party application is granted access via the data aggregator. For example, an expanded application-specific user account authorization token may specify that a user grants access to Application1 only to small business accounts via the data aggregator, and also restricts access only to account number and to account balances, but not to account transactions. Token obtaining module 212 may be configured to obtain, by the computing platform, an expanded application-specific user account authorization token specifying access to be granted to a third party application with respect to an application-specific set of one or more user accounts and with respect to an application-specific set of one or more data types. Permissions determination module 214 may be configured to determine, by the computing platform, access permissions associated with the data transfer instructions based on the combination of the aggregator access profile and the expanded application-specific user account authorization token. Notification transmission module 216 may be configured to transmit, by the computing platform and to the data aggregator and for subsequent transmission to the third party application, the access notification specifying: the combination of the one or more APIs, and the application-specific set of one or more user accounts, and the application-specific set of one or more data types to which the data aggregator and the third party application are granted access.

Permissions modifying module 220 may be configured to modify, using hypertext transfer protocol (HTTP), the access permissions, by employing a combination of a verb and uniform resource identifier (URI).

In some embodiments, computing platform(s) 202, remote platform(s) 204, and/or external resources 222 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 222 may be operatively linked via some other communication media.

A given remote platform 204 may include one or more processors configured to execute computer program modules. The computer program modules may be configured to enable an expert or user associated with the given remote platform 204 to interface with system 200 and/or external resources 222, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 222 may include sources of information outside of system 200, external entities participating with system 200, and/or other resources. In some embodiments, some or all of the functionality attributed herein to external resources 222 may be provided by resources included in system 200.

Computing platform(s) 202 may include electronic storage 224, one or more processors 226, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 224 may comprise non-transitory storage media that electronically stores information. The electronic storage media of electronic storage 224 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 224 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 224 may include one or more virtual storage resources (e.g., cloud storage, a virtual private network, and/or other virtual storage resources). Electronic storage 224 may store software algorithms, information determined by processor(s) 226, information received from computing platform(s) 202, information received from remote platform(s) 204, and/or other information that enables computing platform(s) 202 to function as described herein.

Processor(s) 226 may be configured to provide information processing capabilities in computing platform(s) 202. As such, processor(s) 226 may include one or more of a digital processor, an analog processor, a digital circuit designed to process information, an analog circuit designed to process information, a state machine, and/or other mechanisms for electronically processing information. Although processor(s) 226 is shown in FIG. 2 as a single entity, this is for illustrative purposes only. In some embodiments, processor(s) 226 may include a plurality of processing units. These processing units may be physically located within the same device, or processor(s) 226 may represent processing functionality of a plurality of devices operating in coordination. Processor(s) 226 may be configured to execute modules 208, 210, 212, 214, 216, 218, and/or 220, and/or other modules. Processor(s) 226 may be configured to execute modules 208, 210, 212, 214, 216, 218, and/or 220, and/or other modules by software; hardware; firmware; some combination of software, hardware, and/or firmware; and/or other mechanisms for configuring processing capabilities on processor(s) 226. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, and/or 220 are illustrated in FIG. 2 as being implemented within a single processing unit, in embodiments in which processor(s) 226 includes multiple processing units, one or more of modules 208, 210, 212, 214, 216, 218, and/or 220 may be implemented remotely from the other modules. The description of the functionality provided by the different modules 208, 210, 212, 214, 216, 218, and/or 220 described below is for illustrative purposes, and is not intended to be limiting, as any of modules 208, 210, 212, 214, 216, 218, and/or 220 may provide more or less functionality than is described. For example, one or more of modules 208, 210, 212, 214, 216, 218, and/or 220 may be eliminated, and some or all of its functionality may be provided by other ones of modules 208, 210, 212, 214, 216, 218, and/or 220. As another example, processor(s) 226 may be configured to execute one or more additional modules that may perform some or all of the functionality attributed below to one of modules 208, 210, 212, 214, 216, 218, and/or 220.

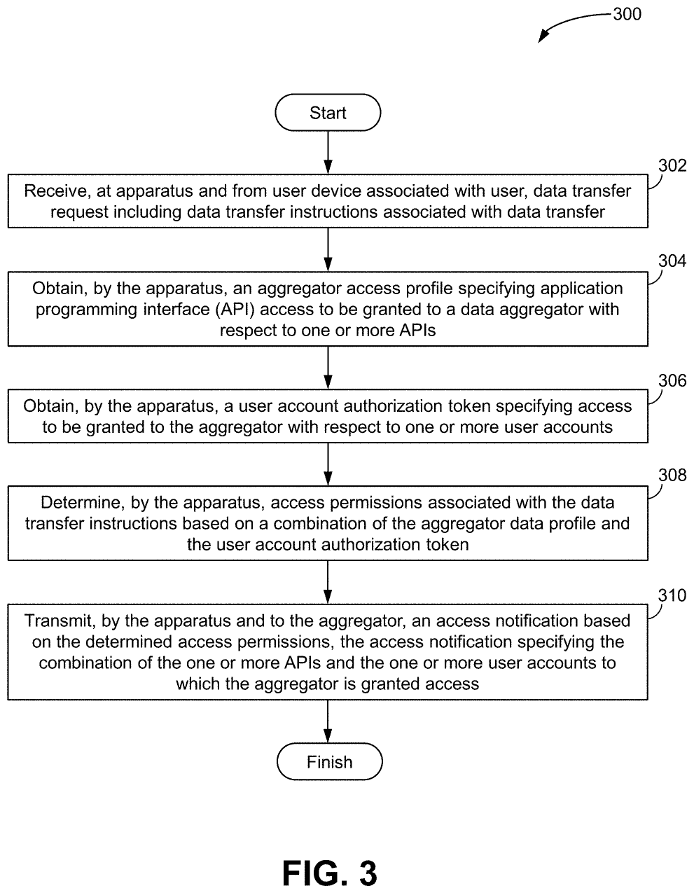

FIG. 3 illustrates a method 300 for processing a data access request, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include receiving, at an apparatus and from a user device associated with a user, a data transfer request including data transfer instructions associated with the data transfer. Operation 302 may be performed by one or more hardware processors configured by machine-readable instructions including a module that is the same as or similar to request receipt module 208, in accordance with one or more embodiments.

An operation 304 may include obtaining, by the apparatus, an aggregator access profile specifying application programming interface access to be granted to a data aggregator with respect to one or more APIs. Operation 304 may be performed by one or more hardware processors configured by machine-readable instructions including a module that is the same as or similar to profile obtaining module 210, in accordance with one or more embodiments.

An operation 306 may include obtaining, by the apparatus, a user account authorization token specifying access to be granted to the data aggregator with respect to one or more user accounts. Operation 306 may be performed by one or more hardware processors configured by machine-readable instructions including a module that is the same as or similar to token obtaining module 212, in accordance with one or more embodiments.

An operation 308 may include determining, by the apparatus, access permissions associated with the data transfer instructions based on a combination of the aggregator access profile and the user account authorization token. Operation 308 may be performed by one or more hardware processors configured by machine-readable instructions including a module that is the same as or similar to permissions determination module 214, in accordance with one or more embodiments.

An operation 310 may include transmitting, by the apparatus and to the data aggregator, an access notification based on the determined access permissions. The access notification may specify the combination of the one or more APIs and the one or more user accounts to which the data aggregator is granted access. Operation 310 may be performed by one or more hardware processors configured by machine-readable instructions including a module that is the same as or similar to notification transmission module 216, in accordance with one or more embodiments.

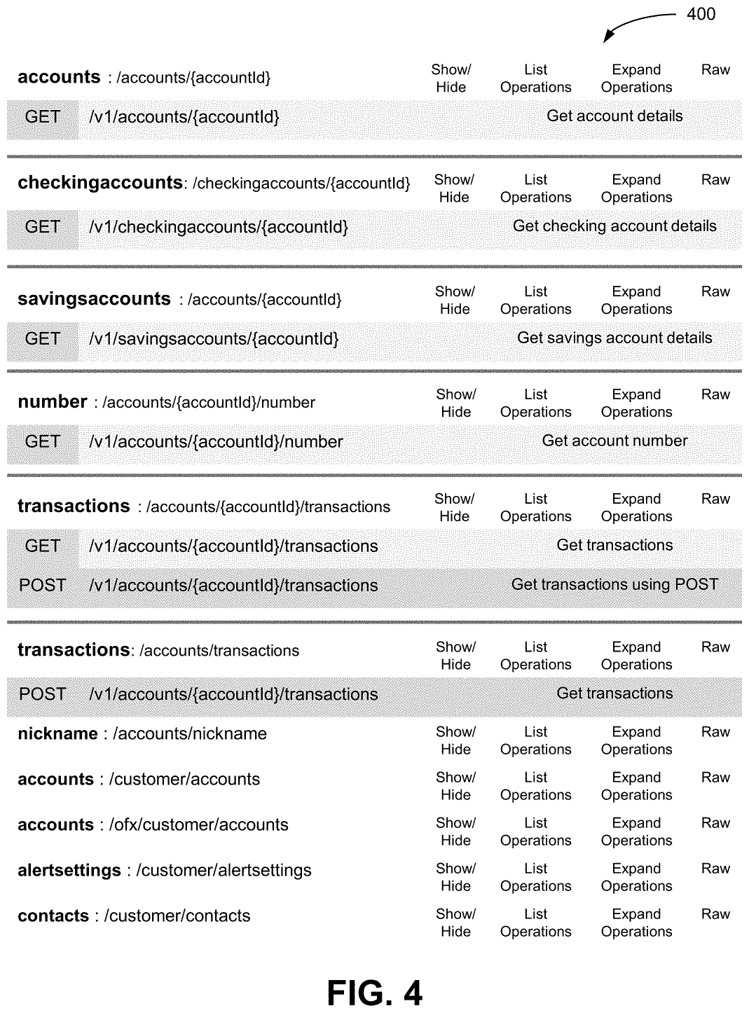

FIG. 4 illustrates an example indication 400, for example a screenshot, of a means for modifying access permissions for a method for processing a data access request, in accordance with one or more embodiments. The example implementation shown in FIG. 4 illustrates an approach using HTTP to provide easy access to modifying permissions, using a combination of verb and uniform resource identifier (URI). For example, an aggregator access profile can access an account defined by a URI v1/accounts/accountID and define dynamically what the data aggregator is permitted to access.

Other examples are shown in FIG. 4 with respect to specifying access permissions, using a combination of a verb and a URI, for checking accounts, savings accounts, account number and transactions. This approach can enable adding new methods and synchronizing to environments, without requiring modification of a configuration file or other stored profile data. This approach can also stop or prevent an aggregator from obtaining access, and add new aggregators to obtain access, and change credentials associated with an aggregator.

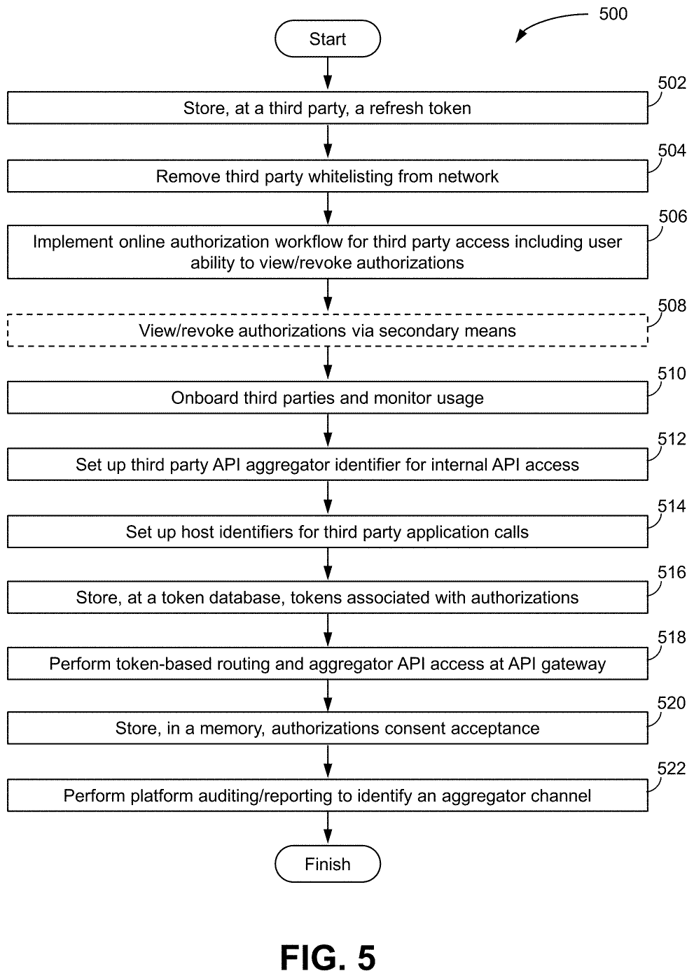

FIG. 5 illustrates a method for processing a data request, in accordance with one or more embodiments. In an example embodiment, the method shown in FIG. 5 is performed in relation to a system configured to specify granular access to user data, such as open banking data, using a combination of: a token specifying user account access; and an aggregator access profile specifying API access. The system may include a communication device, an aggregator interface unit in communication with a data aggregator, a server, and a token/profile database, which interact with a third party financial tool (app).

The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting.

In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 500.

An operation 502 may include storing, at the third party, a refresh token. In an embodiment, operation 502 includes storing, at the third party, a refresh token only. Operation 502 enables no longer having a requirement for user credential storage. An operation 504 may include removing third party whitelisting from a network. Operation 506 may include implementing an online authorization workflow for third party data access including user ability to view/revoke authorizations, for example in relation to a dashboard provided to a user. An optional operation 508 may include the ability to view or revoke authorizations via a secondary means, for example associated with a customer service determination or a fraud determination.

An operation 510 may include onboarding third parties and monitoring usage. An operation 512 may include setting up a third party API aggregator identifier for internal API access. An operation 514 may include setting up host identifiers for third party application calls. An operation 516 may include storing, at a token database, the tokens associated with the granted authorizations. An operation 518 may include performing token-based routing and aggregator API access, for example at an API gateway. An operation 520 may include storing, in a memory, authorizations consent acceptance. An operation 522 may include performing platform auditing and/or reporting to identify an aggregator channel.

According to certain embodiments, an access token and a refresh token may be used. The access token may used as a bearer token for API access and may be short lived, In an embodiment, the access token matches the token lifespan for the mobile/table and responsive user interface, which may for example be 9 minutes. The refresh token is a long lived token used to obtain access tokens. The refresh token may have access for N days based upon what the data aggregator has asked for in the authorization request and what is configured for the client_ID.

In an implementation, a third party protects the refresh tokens only using it from their servers never passing back to clients. Similarly, the access token may be used only from the aggregator services. In an embodiment, the refresh token is stored securely, and the third party store their clientid and the accompanying secret securely. In an embodiment, the secret is stored in an encrypted format as this is the data aggregator's password for obtaining tokens. In an example implementation, encrypted passwords may be used for aggregators to access the API, for example using a client ID and a client secret. The encrypted password may go into the profile for the data aggregator, and access may be managed at the data aggregator level (client ID). Embodiments of the present disclosure may be described as providing a method of configuring aggregator access to banking data.

Embodiments of the present disclosure leverage open banking, which enables users or customers to share banking information out, for example with third party fintech apps. According to an embodiment, the present disclosure provides an infrastructure and uses APIs to securely tokenize, encrypt and share data out with third parties identified by customers. Embodiments of the present disclosure give data without having to share bank credentials, and replace passwords with tokens. Embodiments of the present disclosure also provide dashboard to show which tools/apps have access to data, and enable a user to revoke access at any time, rather than the typical approach of going through a data aggregator/intermediary partner. Embodiments of the present disclosure enable an institution to measure and track which apps are connected to their system, and can revoke tokens to limit data flow in case of a security incident.

From a user or customer perspective, embodiments of the present disclosure provide one or more of the following: gives banking data directly from a financial institution (FI) without revealing username & password to non-FI applications and tools; views which tools/applications have access to their data; and revokes that access at any time.

From a FI perspective, embodiments of the present disclosure provide one or more of the following: client device recognition and verification; partner data breach blast radius limited to that Partner at most; consistent edge & perimeter security mechanisms; measurable data access provides visibility on when & who accesses data; lower operational risk; customers are better protected.

From a partner or aggregator perspective, embodiments of the present disclosure provide one or more of the following: enables FI to handle authentication; purpose built for partner connected API integration & usage; edge and device security controls mitigate botnet exploitation and stolen credential usage; token storage over username/password for reliable, secure, safer and lower risk integration; better partner support & easier operability; no more cookies.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following CLAUSES, with specific features laid out in the dependent clauses:

One aspect of the present disclosure relates to a computing platform configured for processing a data request. The computing platform may include one or more hardware processors configured by machine-readable instructions stored on a non-transient computer-readable storage medium. The processor(s) may be configured to receive, at an apparatus and from a user device associated with a user, a data transfer request including data transfer instructions associated with the data transfer. The processor(s) may be configured to obtain, by the apparatus, a user account authorization token specifying access to be granted to a third party application with respect to one or more user accounts. The processor(s) may be configured to obtain, by the apparatus, an aggregator access profile specifying access to be granted to a data aggregator with respect to one or more communication functions. The one or more communication functions may include a means for communication and operation between entities or devices, and may specify a format or structure for such communication. For example, a communication function may specify commands or protocols to be used in order to access a particular data type. In an implementation, access to a particular data type may be blocked or enabled by blocking or enabling an associated communication function. The processor(s) may be configured to determine, by the apparatus, access permissions associated with the data transfer instructions based on a combination of the user account authorization token and the aggregator access profile. The processor(s) may be configured to transmit, by the apparatus and to the data aggregator, an access notification based on the determined access permissions. The access notification may specify the combination of the one or more account data types and the one or more user accounts to which the data aggregator is granted access.

Another aspect of the present disclosure relates to a computing platform configured for processing a data request. The computing platform may include one or more hardware processors configured by machine-readable instructions stored on a non-transient computer-readable storage medium. The processor(s) may be configured to receive, at the computing platform and from a user device associated with a user, a data transfer request including data transfer instructions associated with the data transfer. The processor(s) may be configured to obtain, by the computing platform, a user account authorization token specifying access to be granted to a third party application with respect to one or more user accounts. The processor(s) may be configured to obtain, by the computing platform, a data type access profile specifying access to be granted to the third party application with respect to one or more account data types. The processor(s) may be configured to determine, by the computing platform, access permissions associated with the data transfer instructions based on a combination of the user account authorization token and the user profile. The processor(s) may be configured to transmit, by the computing platform and to the third party application, an access notification based on the determined access permissions. The access notification may specify the combination of the one or more account data types and the one or more user accounts to which the third party application is granted access.

In some implementations, the user account authorization token is based on account access permissions granted by the user.

In some implementations, the data type access profile is based on permissions granted by an institution associated with the one or more user accounts.

In some implementations, the one or more processors are further configured to selectively grant the third party application access to one or more application programming interfaces (APIs) associated with the one or more account data types, each API being uniquely associated with a selected account data type.

In some implementations, the one or more processors are further configured to selectively grant the third party application access to the one or more APIs based on the data type access profile obtained from an institution associated with the one or more user accounts.

In some implementations, the third party application comprises an aggregator, and wherein the data type access profile comprises an aggregator access profile specifying the one or more APIs to which the data aggregator is granted access.

In some implementations, the third party application comprises an aggregator, and wherein the data type access profile comprises an aggregator access profile specifying the one or more account data types to which the data aggregator is granted access.

In some implementations, the one or more processors are further configured to determine, by the computing platform, token-based access permissions associated with the data transfer instructions based on a combination of the user account authorization token and the user profile.

In some implementations, the one or more processors are further configured to transmit, by the computing platform and to the third party application, a token-based access notification based on the determined access permissions. The token-based access notification may specify the combination of the one or more account data types and the one or more user accounts to which the third party application is granted access.

In some implementations, the one or more processors are further configured to modify, using hypertext transfer protocol (HTTP), the access permissions, by employing a combination of a verb and uniform resource identifier (URI).

In some implementations, the user device comprises a customer device associated with a customer.

In some implementations, the one or more user accounts comprise one or more customer accounts at a financial institution.

In some implementations, the data type access profile is obtained from the financial institution.

Yet another aspect of the present disclosure relates to a method for processing a data request. The method may include receiving, at an apparatus and from a user device associated with a user, a data transfer request including data transfer instructions associated with the data transfer. The method may include obtaining, by the apparatus, a user account authorization token specifying access to be granted to a third party application with respect to one or more user accounts. The method may include obtaining, by the apparatus, a data type access profile specifying access to be granted to the third party application with respect to one or more account data types. The method may include determining, by the apparatus, access permissions associated with the data transfer instructions based on a combination of the user account authorization token and the user profile. The method may include transmitting, by the apparatus and to the third party application, an access notification based on the determined access permissions, the access notification specifying the combination of the one or more account data types and the one or more user accounts to which the third party application is granted access.

In some implementations, the user account authorization token is based on account access permissions granted by the user.

In some implementations, the data type access profile is based on permissions granted by an institution associated with the one or more user accounts.

In some implementations, the method may further include selectively granting the third party application access to one or more application programming interfaces (APIs) associated with the one or more account data types, each API being uniquely associated with a selected account data type.

In some implementations, the method may further include selectively granting the third party application access to the one or more APIs based on the data type access profile obtained from an institution associated with the one or more user accounts.

In some implementations, the third party application comprises an aggregator, and wherein the data type access profile comprises an aggregator access profile specifying the one or more APIs to which the data aggregator is granted access.

In some implementations, the third party application comprises an aggregator, and wherein the data type access profile comprises an aggregator access profile specifying the one or more account data types to which the data aggregator is granted access.

In some implementations, the method may further include determining, by the apparatus, token-based access permissions associated with the data transfer instructions based on a combination of the user account authorization token and the user profile.

In some implementations, the method may further include transmitting, by the apparatus and to the third party application, a token-based access notification based on the determined access permissions. The token-based access notification may specify the combination of the one or more account data types and the one or more user accounts to which the third party application is granted access.

In some implementations, the method may further include modifying, using hypertext transfer protocol (HTTP), the access permissions, by employing a combination of a verb and uniform resource identifier (URI).

In some implementations, the user device comprises a customer device associated with a customer.

In some implementations, the one or more user accounts comprise one or more customer accounts at a financial institution.

In some implementations, the data type access profile is obtained from the financial institution.

Still another aspect of the present disclosure relates to a non-transient computer-readable storage medium having instructions embodied thereon, the instructions being executable by one or more processors to perform a computer-implemented method for processing a data request. The method may include receiving, at an apparatus and from a user device associated with a user, a data transfer request including data transfer instructions associated with the data transfer. The method may include obtaining, by the apparatus, a user account authorization token specifying access to be granted to a third party application with respect to one or more user accounts. The method may include obtaining, by the apparatus, a data type access profile specifying access to be granted to the third party application with respect to one or more account data types. The method may include determining, by the apparatus, access permissions associated with the data transfer instructions based on a combination of the user account authorization token and the user profile. The method may include transmitting, by the apparatus and to the third party application, an access notification based on the determined access permissions. The access notification may specify the combination of the one or more account data types and the one or more user accounts to which the third party application is granted access.

In some implementations, the user account authorization token is based on account access permissions granted by the user.

In some implementations, the data type access profile is based on permissions granted by an institution associated with the one or more user accounts.

In some implementations, the method may further include selectively granting the third party application access to one or more application programming interfaces (APIs) associated with the one or more account data types, each API being uniquely associated with a selected account data type.

In some implementations, the method may further include selectively granting the third party application access to the one or more APIs based on the data type access profile obtained from an institution associated with the one or more user accounts.

In some implementations, the third party application comprises an aggregator, and wherein the data type access profile comprises an aggregator access profile specifying the one or more APIs to which the data aggregator is granted access.

In some implementations, the third party application comprises an aggregator, and wherein the data type access profile comprises an aggregator access profile specifying the one or more account data types to which the data aggregator is granted access.

In some implementations, the method may further include determining, by the apparatus, token-based access permissions associated with the data transfer instructions based on a combination of the user account authorization token and the user profile.

In some implementations, the method may further include transmitting, by the apparatus and to the third party application, a token-based access notification based on the determined access permissions. The token-based access notification may specify the combination of the one or more account data types and the one or more user accounts to which the third party application is granted access.

In some implementations, the method may further include modifying, using hypertext transfer protocol (HTTP), the access permissions, by employing a combination of a verb and uniform resource identifier (URI).

In some implementations, the user device comprises a customer device associated with a customer.

In some implementations, the one or more user accounts comprise one or more customer accounts at a financial institution.

In some implementations, the data type access profile is obtained from the financial institution.

Yet another aspect of the present disclosure relates to a system configured for processing a data request. The system may include one or more hardware processors configured by machine-readable instructions. The processor(s) may be configured to receive, at an apparatus and from a user device associated with a user, a data transfer request including data transfer instructions associated with the data transfer. The processor(s) may be configured to obtain, by the apparatus, a user account authorization token specifying access to be granted to a third party application with respect to one or more user accounts. The processor(s) may be configured to obtain, by the apparatus, a data type access profile specifying access to be granted to the third party application with respect to one or more account data types. The processor(s) may be configured to determine, by the apparatus, access permissions associated with the data transfer instructions based on a combination of the user account authorization token and the user profile. The processor(s) may be configured to transmit, by the apparatus and to the third party application, an access notification based on the determined access permissions. The access notification may specify the combination of the one or more account data types and the one or more user accounts to which the third party application is granted access.

In some implementations, the user account authorization token is based on account access permissions granted by the user.

In some implementations, the data type access profile is based on permissions granted by an institution associated with the one or more user accounts.

In some implementations, the processor(s) may be further configured to selectively grant the third party application access to one or more application programming interfaces (APIs) associated with the one or more account data types, each API being uniquely associated with a selected account data type.

In some implementations, the processor(s) may be further configured to selectively grant the third party application access to the one or more APIs based on the data type access profile obtained from an institution associated with the one or more user accounts.

In some implementations, the third party application comprises an aggregator, and wherein the data type access profile comprises an aggregator access profile specifying the one or more APIs to which the data aggregator is granted access.

In some implementations, the third party application comprises an aggregator, and wherein the data type access profile comprises an aggregator access profile specifying the one or more account data types to which the data aggregator is granted access.

In some implementations, the processor(s) may be further configured to determine, by the apparatus, token-based access permissions associated with the data transfer instructions based on a combination of the user account authorization token and the user profile.

In some implementations, the processor(s) may be further configured to transmit, by the apparatus and to the third party application, a token-based access notification based on the determined access permissions. The token-based access notification may specify the combination of the one or more account data types and the one or more user accounts to which the third party application is granted access.

In some implementations, the processor(s) may be further configured to modify, using hypertext transfer protocol (HTTP), the access permissions, by employing a combination of a verb and uniform resource identifier (URI).

In some implementations, the user device comprises a customer device associated with a customer.

In some implementations, the one or more user accounts comprise one or more customer accounts at a financial institution.

In some implementations, the data type access profile is obtained from the financial institution.

Even another aspect of the present disclosure relates to a system configured for processing a data request. The system may include means for receiving, at an apparatus and from a user device associated with a user, a data transfer request including data transfer instructions associated with the data transfer. The system may include means for obtaining, by the apparatus, a user account authorization token specifying access to be granted to a third party application with respect to one or more user accounts. The system may include means for obtaining, by the apparatus, a data type access profile specifying access to be granted to the third party application with respect to one or more account data types. The system may include means for determining, by the apparatus, access permissions associated with the data transfer instructions based on a combination of the user account authorization token and the user profile. The system may include means for transmitting, by the apparatus and to the third party application, an access notification based on the determined access permissions. The access notification may specify the combination of the one or more account data types and the one or more user accounts to which the third party application is granted access.

In some implementations, the user account authorization token is based on account access permissions granted by the user.

In some implementations, the data type access profile is based on permissions granted by an institution associated with the one or more user accounts.

In some implementations, the system may further include means for selectively granting the third party application access to one or more application programming interfaces (APIs) associated with the one or more account data types, each API being uniquely associated with a selected account data type.

In some implementations, the system may further include means for selectively granting the third party application access to the one or more APIs based on the data type access profile obtained from an institution associated with the one or more user accounts.

In some implementations, the third party application comprises an aggregator, and wherein the data type access profile comprises an aggregator access profile specifying the one or more APIs to which the data aggregator is granted access.

In some implementations, the third party application comprises an aggregator, and wherein the data type access profile comprises an aggregator access profile specifying the one or more account data types to which the data aggregator is granted access.

In some implementations, the system may further include means for determining, by the apparatus, token-based access permissions associated with the data transfer instructions based on a combination of the user account authorization token and the user profile.

In some implementations, the system may further include means for transmitting, by the apparatus and to the third party application, a token-based access notification based on the determined access permissions. The token-based access notification may specify the combination of the one or more account data types and the one or more user accounts to which the third party application is granted access.

In some implementations, the system may further include means for modifying, using hypertext transfer protocol (HTTP), the access permissions, by employing a combination of a verb and uniform resource identifier (URI).

In some implementations, the user device comprises a customer device associated with a customer.

In some implementations, the one or more user accounts comprise one or more customer accounts at a financial institution.

In some implementations, the data type access profile is obtained from the financial institution.

What is claimed is:

1. A computing platform configured for processing a data request, the computing platform comprising:
a non-transient computer-readable storage medium having instructions embodied thereon; and
one or more processors configured to execute the instructions to:
receive, at the computing platform and from a user device associated with a user, a data transfer request including data transfer instructions associated with the data transfer;
obtain, by the computing platform, an aggregator access profile specifying application programming interface (API) access to be granted to a data aggregator with respect to one or more APIs;
obtain, by the computing platform, a user account authorization token specifying access to be granted to the data aggregator with respect to one or more user accounts;
determine, by the computing platform, access permissions associated with the data transfer instructions based on a combination of the aggregator access profile and the user account authorization token; and
transmit, by the computing platform and to the data aggregator, an access notification based on the determined access permissions, the access notification specifying the combination of the one or more APIs and the one or more user accounts to which the data aggregator is granted access.

2. The computing platform of claim 1, wherein the user account authorization token is based on account access permissions specified by the user.

3. The computing platform of claim 1, wherein the aggregator access profile is based on permissions specified by an institution associated with the one or more APIs.

4. The computing platform of claim 1, wherein the one or more processors are further configured to execute the instructions to:
obtain, by the computing platform, an expanded user account authorization token specifying access to be granted to the data aggregator with respect to one or more user accounts and with respect to one or more data types;
determine, by the computing platform, access permissions associated with the data transfer instructions based on the combination of the aggregator access profile and the expanded user account authorization token; and
transmit, by the computing platform and to the data aggregator, the access notification based on the determined access permissions, the access notification specifying the combination of the one or more APIs and the one or more user accounts and the one or more data types to which the data aggregator is granted access.

5. The computing platform of claim 1, wherein the one or more processors are further configured to execute the instructions to:
obtain, by the computing platform, an application-specific user account authorization token specifying access to be granted to a third party application with respect to an application-specific set of one or more user accounts;
determine, by the computing platform, access permissions associated with the data transfer instructions based on the combination of the aggregator access profile and the application-specific user account authorization token; and
transmit, by the computing platform and to the data aggregator and for subsequent transmission to the third party application, the access notification based on the determined access permissions, the access notification specifying the combination of the one or more APIs and the application-specific set of one or more user accounts to which the data aggregator and the third party application are granted access.

6. The computing platform of claim 1, wherein the one or more processors are further configured to execute the instructions to:
obtain, by the computing platform, an expanded application-specific user account authorization token specifying access to be granted to a third party application with respect to an application-specific set of one or more user accounts and with respect to an application-specific set of one or more data types;
determine, by the computing platform, access permissions associated with the data transfer instructions based on the combination of the aggregator access profile and the expanded application-specific user account authorization token; and
transmit, by the computing platform and to the data aggregator and for subsequent transmission to the third party application, the access notification based on the determined access permissions, the access notification specifying the combination of the one or more APIs and the application-specific set of one or more user accounts and the application-specific set of one or more data types to which the data aggregator and the third party application are granted access.

7. The computing platform of claim 1, wherein the one or more processors are further configured to execute the instructions to:
determine, by the computing platform, token-based access permissions associated with the data transfer instructions based on a combination of the aggregator access profile and the user account authorization token; and
transmit, by the computing platform and to the data aggregator, a token-based access notification based on the determined access permissions, the token-based access notification specifying the combination of the one or more APIs and the one or more user accounts to which the data aggregator is granted access.

8. The computing platform of claim 1, wherein the one or more processors are further configured to execute the instructions to:
modify, using hypertext transfer protocol (HTTP), the access permissions, by employing a combination of a verb and uniform resource identifier (URI).

9. The computing platform of claim 1, wherein:
the user device comprises a customer device associated with a customer;
the one or more user accounts comprise one or more customer accounts at a financial institution; and
the data type access profile is obtained from the financial institution.

10. A processor-implemented method of processing a data request, the method comprising:
receiving, at an apparatus and from a user device associated with a user, a data transfer request including data transfer instructions associated with the data transfer;
obtaining, by the apparatus, an aggregator access profile specifying application programming interface (API) access to be granted to a data aggregator with respect to one or more APIs;
obtaining, by the apparatus, a user account authorization token specifying access to be granted to the data aggregator with respect to one or more user accounts;
determining, by the apparatus, access permissions associated with the data transfer instructions based on a combination of the aggregator access profile and the user account authorization token; and
transmitting, by the apparatus and to the data aggregator, an access notification based on the determined access permissions, the access notification specifying the combination of the one or more APIs and the one or more user accounts to which the data aggregator is granted access.

11. The method of claim 10, wherein the user account authorization token is based on account access permissions specified by the user.

12. The method of claim 10, wherein the aggregator access profile is based on permissions specified by an institution associated with the one or more APIs.

13. The method of claim 10, further comprising:
obtaining, by the apparatus, an expanded user account authorization token specifying access to be granted to the data aggregator with respect to one or more user accounts and with respect to one or more data types;
determining, by the apparatus, access permissions associated with the data transfer instructions based on the combination of the aggregator access profile and the expanded user account authorization token; and
transmitting, by the apparatus and to the data aggregator, the access notification based on the determined access permissions, the access notification specifying the combination of the one or more APIs and the one or more user accounts and the one or more data types to which the data aggregator is granted access.

14. The method of claim 10, further comprising:
obtaining, by the apparatus, an application-specific user account authorization token specifying access to be granted to a third party application with respect to an application-specific set of one or more user accounts;
determining, by the apparatus, access permissions associated with the data transfer instructions based on the combination of the aggregator access profile and the application-specific user account authorization token; and
transmitting, by the apparatus and to the data aggregator and for subsequent transmission to the third party application, the access notification based on the determined access permissions, the access notification specifying the combination of the one or more APIs and the application-specific set of one or more user accounts to which the data aggregator and the third party application are granted access.

15. The method of claim 10, further comprising:
obtaining, by the apparatus, an expanded application-specific user account authorization token specifying access to be granted to a third party application with respect to an application-specific set of one or more user accounts and with respect to an application-specific set of one or more data types;
determining, by the apparatus, access permissions associated with the data transfer instructions based on the combination of the aggregator access profile and the expanded application-specific user account authorization token; and
transmitting, by the apparatus and to the data aggregator and for subsequent transmission to the third party application, the access notification based on the determined access permissions, the access notification specifying the combination of the one or more APIs and the application-specific set of one or more user accounts and the application-specific set of one or more data types to which the data aggregator and the third party application are granted access.

16. The method of claim 10, further comprising:
determining, by the apparatus, token-based access permissions associated with the data transfer instructions based on a combination of the aggregator access profile and the user account authorization token; and
transmitting, by the apparatus and to the data aggregator, a token-based access notification based on the determined access permissions, the token-based access notification specifying the combination of the one or more APIs and the one or more user accounts to which the data aggregator is granted access.

17. The method of claim 10, further comprising:
modifying, using hypertext transfer protocol (HTTP), the access permissions, by employing a combination of a verb and uniform resource identifier (URI).

18. A non-transient computer-readable storage medium having instructions embodied thereon, the instructions being executable by one or more processors to perform a computer-implemented method for method of processing a data request, the method comprising:
receiving, at an apparatus and from a user device associated with a user, a data transfer request including data transfer instructions associated with the data transfer;
obtaining, by the apparatus, an aggregator access profile specifying application programming interface (API) access to be granted to a data aggregator with respect to one or more APIs;
obtaining, by the apparatus, a user account authorization token specifying access to be granted to the data aggregator with respect to one or more user accounts;
determining, by the apparatus, access permissions associated with the data transfer instructions based on a combination of the aggregator access profile and the user account authorization token; and
transmitting, by the apparatus and to the data aggregator, an access notification based on the determined access permissions, the access notification specifying the combination of the one or more APIs and the one or more user accounts to which the data aggregator is granted access.

19. The computer-readable storage medium of claim 18, wherein the method further comprises:
obtaining, by the apparatus, an application-specific user account authorization token specifying access to be granted to a third party application with respect to an application-specific set of one or more user accounts;
determining, by the apparatus, access permissions associated with the data transfer instructions based on the combination of the aggregator access profile and the application-specific user account authorization token; and
transmitting, by the apparatus and to the data aggregator and for subsequent transmission to the third party application, the access notification based on the determined access permissions, the access notification specifying the combination of the one or more APIs and the application-specific set of one or more user accounts to which the data aggregator and the third party application are granted access.

20. The computer-readable storage medium of claim 18, wherein the method further comprises:
obtaining, by the apparatus, an expanded application-specific user account authorization token specifying access to be granted to a third party application with respect to an application-specific set of one or more user accounts and with respect to an application-specific set of one or more data types;
determining, by the apparatus, access permissions associated with the data transfer instructions based on the combination of the aggregator access profile and the expanded application-specific user account authorization token; and
transmitting, by the apparatus and to the data aggregator and for subsequent transmission to the third party application, the access notification based on the determined access permissions, the access notification specifying the combination of the one or more APIs and the application-specific set of one or more user accounts and the application-specific set of one or more data types to which the data aggregator and the third party application are granted access.
